(19) United States
(12) Patent Application Publication
(10) Pub. No.: US 2014/0208596 A1
(43) Pub. Date: Jul. 31, 2014

(54) Sliding Blade Knife

(71) Applicant: Acme United Corporation, Fairfield, CT (US)

(72) Inventors: Richard S. Constantine, Milford, CT (US); Yani Deros, Phoenix, AZ (US)

(73) Assignee: Acme United Corporation, Fairfield, CT (US)

(21) Appl. No.: 14/168,243

(22) Filed: Jan. 30, 2014

Related U.S. Application Data
(60) Provisional application No. 61/758,454, filed on Jan. 30, 2013.

(51) Int. Cl. B26B 1/08

(52) U.S. Cl. CPC B26B 1/08
USPC 30/162

(57) ABSTRACT

A sliding blade knife has an elongated frame-like handle. A blade is longitudinally positionable relative to the handle and is transformable between a stable extended and a stable retracted position relative to the handle. An exteriorly accessible button is depressible to allow the blade to be transformed between the retracted positions and the stable extended position. In the extended position, the blade projects outwardly of the handle for usage.

### BACKGROUND

This disclosure relates generally to blade knives used for hunting, fishing and sporting applications. More particularly, this disclosure relates to blade knives having a blade which is positionable in a protective case.

### SUMMARY

Briefly stated, a sliding blade knife comprises an elongated frame-like handle. A blade is longitudinally positionable relative to the handle. The handle comprises a structure which defines an extended and a retracted position disposed between the ends of a guide slot. A spring loaded assembly comprises a button having an operating pin engageable with the slot to allow the button to be depressed and the blade to be retracted to a stable, retracted position fully retracted within the handle and longitudinally projected to a stable, extended position wherein the blade projects outwardly of the handle for usage.

The handle preferably has a concave finger grip. A spring biases the button to a stable position. The handle comprises transversely opposed pairs of a forward bolster member, a back bolster member and elongated strips which form generally transversely opposed sides defining a pair of spaced, generally parallel planes. The frame, at one side, provides a protective sheath which fully receives a blade in the retracted position. The handle preferably has a central plate-like support frame which defines a longitudinal channel for the blade. Closed plate members are mounted to opposed sides of the support frame in a laminar construction. The concave finger grip is preferably disposed adjacent a forward end of the handle.

### BRIEF DESCRIPTION OF THE DRAWINGS

FIG. 1 is a first side view of a sliding blade knife in a retracted blade position;

FIG. 2 is an inverse opposite side view of the sliding blade knife in the retracted position of FIG. 1;

FIG. 3 is a first side view of the sliding blade knife of FIG. 1 in the extended position;

FIG. 4 is an inverse opposite side view of the extended blade knife in the position of FIG. 3;

FIG. 5 is a first side diagrammatic view of the sliding blade knife in the extended position of FIG. 3; and

FIG. 6 is an exploded perspective view of the sliding blade knife of FIG. 1.

### DETAILED DESCRIPTION

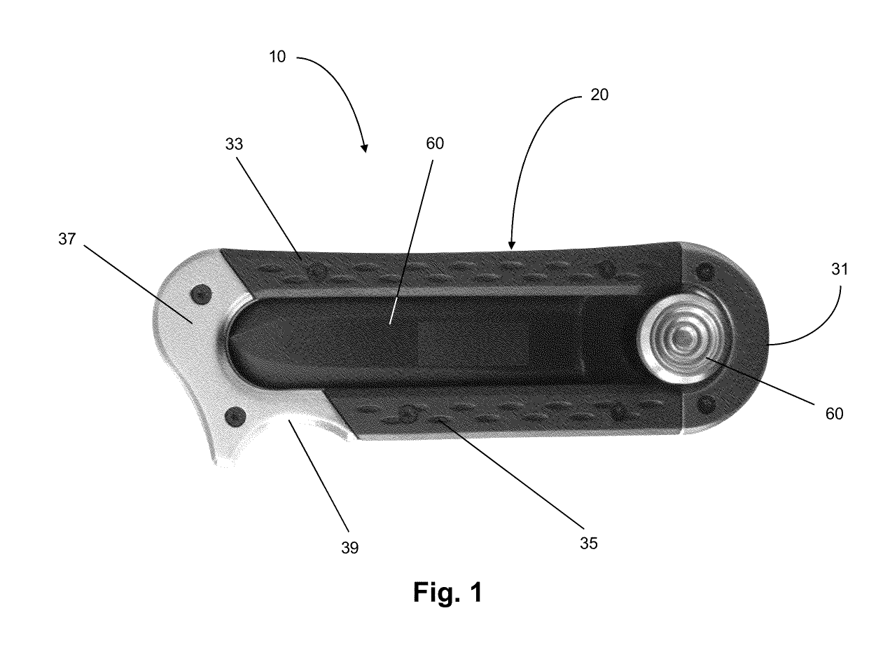

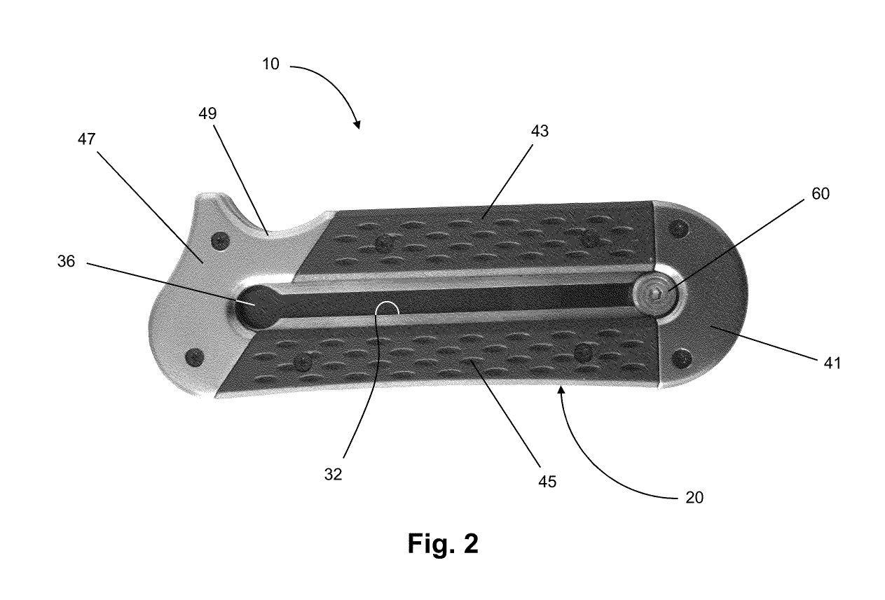

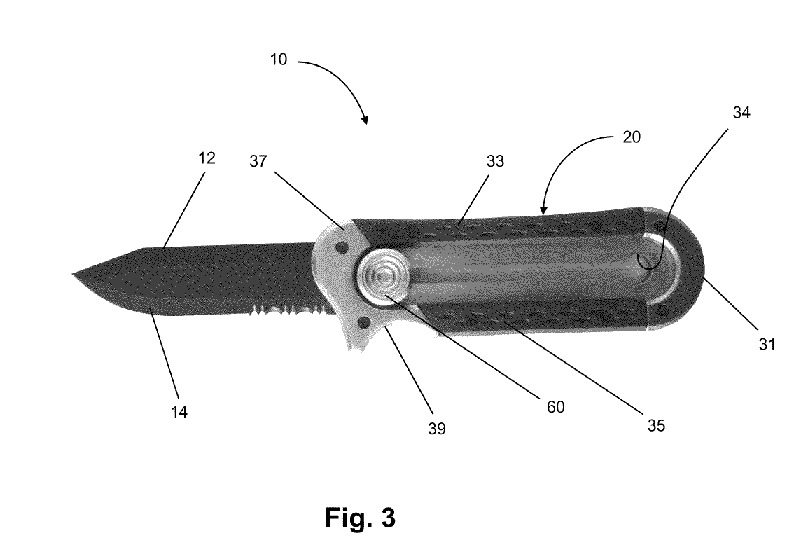

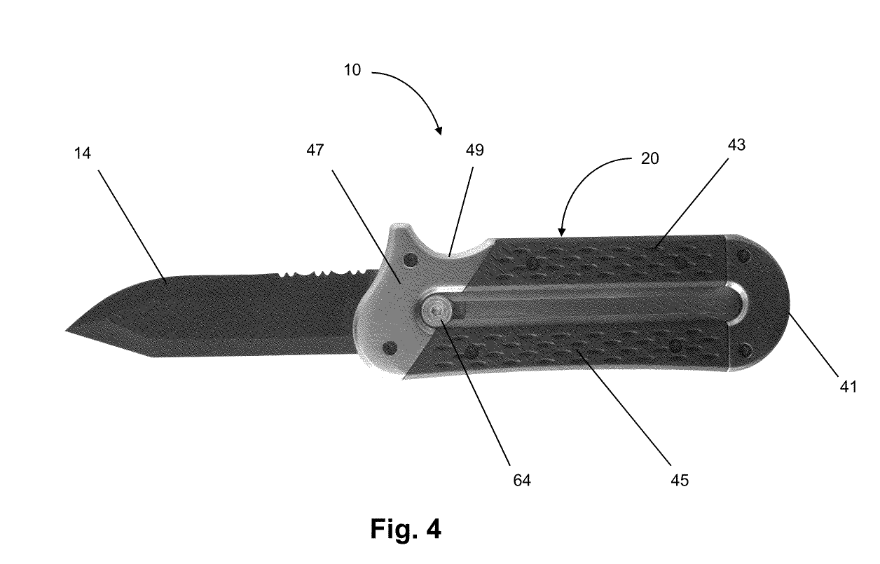

With reference to the drawings wherein like numerals represent like parts throughout the figures, a sliding blade knife is generally designated by the numeral 10. The sliding blade knife 10 is linearly transformable between a retracted protective position (FIGS. 1 and 2) and an extended usage position (FIGS. 3 and 4). In the retracted position, the knife blade is enclosed within a rugged, durable protective frame-like case 20. The protective case 20 also functions as a handle. In the extended and the retracted positions, the blade is maintained in a highly stable, positively locked position.

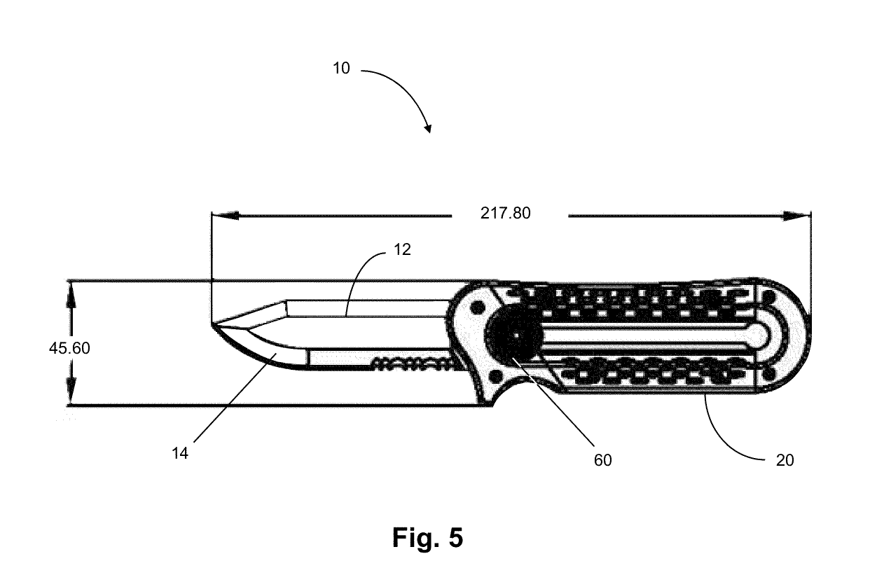

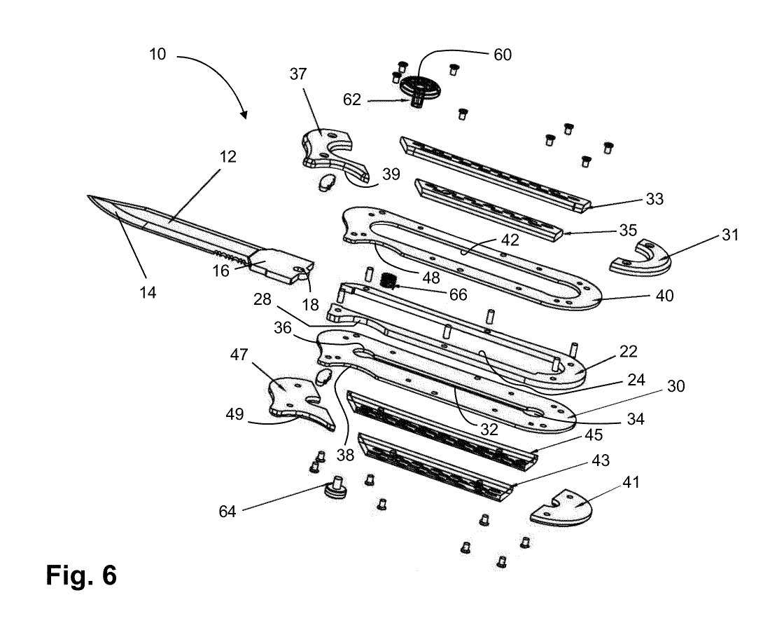

The knife 10 may be employed for hunting, fishing, sporting and other tactical-type applications. In one preferred embodiment, knife 10 has a longitudinally extended dimension of approximately 218 cm and a nominal height of approximately 46 cm, as designated in FIG. 5. The knife includes a blade 12 with a sharpened peripheral edge 14. The blade 12 has a shank 16 with a medial opening 18 (FIG. 6). The blade 12 is preferably a rugged steel member which has a plating composition of nitrides, carbide and/or carbonitrides of titanium and/or chromium.

The handle case 20 has a rugged multi-component elongated construction of laminar form with a contoured exterior surface. The principal central component is an elongated medial support frame 22 having a quasi-U-shaped configuration. The frame 22 defines a longitudinal channel 24 dimensioned to fully receive blade 12. The frame has a peripheral recessed portion 28.

A plate 30 engages against an underside (opposing side) of the frame 22. The plate 30 includes an elongated longitudinal guide slot 32 which terminates in a pair of opposed enlarged circular openings 34 and 36. The plate 30 also includes a frontal recessed portion 38.

A second plate 40 engages the other side (first side) of the frame 22 and includes an enlarged longitudinal slot 42 which is closed, but otherwise generally commensurate with the U-shaped channel 24 of the frame 22. The plate 40 also includes a recessed peripheral portion 48 generally commensurate with the corresponding recessed peripheral portions 28, 38 of the frame 22 and the plate 30, respectively.

A pair of aluminum back bolster members 31 and 41 each have a corresponding recess portion and is respectively mounted to the rear or heel of frame 22. Plastic spaced medial handle strips 33, 35 and 43, 45 are mounted to opposed intermediate sides of the respective plates 30 and 40 by screws or other fasteners. A pair of aluminum forward bolster members 37 and 47 is mounted to opposed forward sides of respective plates 30 and 40. Bolster members 37 and 47 respectively, have recessed peripheral portions 39 and 49 congruent with portions 38 and 28 to form a well-defined concave finger grip 48. The leading and trailing edges of the handle medial strips engage against opposing bolsters 31, 41 and 37, 47 so that the forward, medial and back exterior sides of the handle case 20 have a generally integrated construction upon assembly.

The extreme exterior sides of back bolster member 31, strips 33, 35 and bolster member 37 generally define a plane which is spaced from the central plane of the blade 12. The extreme exterior sides of back bolster member 41, handle strips 43, 45 and forward bolster member 47 also define a plane which is spaced from the central plane of the blade. The planes are spaced a significant transverse distance so that the formed handle case has an integrated construction which is rugged and is also spaced transversely outwardly from the blade to provide a highly protective and functional handle.

A button 60 carries a projecting pin 62 with a recessed circumferential portion of reduced diameter which is dimensioned so that it will enter and slide along the longitudinal guide slot 32 of the plate 30. The pin 62 extends through opening 18. The opposing end of the pin 62 is secured by a rivet or connector head 64.

A spring 66 encircles the pin 62 and biases the button 60 to an extended lock position wherein the enlarged portion of the pin 62 is captured in either of the openings 34 or 36 of the plate member. These openings 34 and 36 define the stable, longitudinally spaced, extended and retracted locked positions for the sliding knife blade. The spring 66 has a significant pre-load force to ensure positional stability at the extended and retracted positions. When the button 60 is depressed, the pin recessed portion aligns with the guide slot 32 and is longitudinally displaceable along the slot for displacement either to or from the end openings 34 and 36. When the button 60 is in the normal (undepressed) state and the pin 62 is received in the opening 34 or 36, the pin 62 functions as a lock stop to thereby prevent longitudinal movement of the blade.

The longitudinal position of the pin 62 functions to determine the position of the blade 12. The sliding blade knife 10 is transformable between a compact retracted position wherein the blade 12 is fully retracted within the handle case and an extended position for usage.

While the foregoing has been set forth to describe a preferred embodiment of the invention, the foregoing should not be deemed a limitation of the invention herein. Accordingly, various modifications, adaptations and alternatives may occur to one skilled in the art without departing from the spirit and the scope of the present invention.

1. A sliding blade knife comprising:
an elongated frame-like handle;
a blade longitudinally positionable relative to said handle;
said handle comprising a structure defining an extended and a retracted position disposed between the ends of a guide slot; and
a spring loaded assembly comprising an exteriorly accessible button having an operating pin engageable with said slot to allow said button to be depressed and said blade to be retracted to a stable retracted position fully retracted within the handle and longitudinally projected to a stable extended position wherein the blade projects outwardly of the handle for usage.

2. The sliding blade knife of claim 1 wherein said handle has a concave finger grip.

3. The sliding blade knife of claim 1 wherein a spring biases said assembly to a stable position.

4. The sliding blade knife of claim 1 wherein said handle comprises transversely opposed pairs of a forward bolster member, a back bolster member and elongated medial strips which form generally transversely opposed sides defining a pair of spaced, generally parallel planes.

5. The sliding blade knife of claim 1 wherein said frame at one side provides a protective sheath which fully receives the blade in the retracted position.

6. The sliding blade knife of claim 1 wherein the handle has a central plate-like support frame which defines a longitudinal channel for said blade and a pair of closed plate members is mounted to opposed sides of said support frame in a laminar construction.

7. A sliding blade knife comprising:
an elongated frame-like handle comprising a handle having a central plate-like support frame which defines a longitudinal channel and a pair of closed plate members mounted to opposed sides of said support frame in a laminar construction;
a blade receivable in said channel and longitudinally positionable relative to said handle;
said handle comprising a structure defining an extended and a retracted position disposed between the ends of a guide slot; and
a spring loaded assembly comprising a button having an operating pin engageable with said slot to allow said blade button to be depressed and said blade to be retracted to a stable retracted position fully retracted within the handle and longitudinally projected to a stable extended position wherein the blade projects outwardly of the handle for usage.

8. The sliding blade knife of claim 7 wherein said handle has a concave finger grip adjacent a forward end.

9. The sliding blade knife of claim 7 wherein a spring biases said button to a stable position.

10. The sliding blade knife of claim 7 wherein said handle comprises transversely opposed pairs of a forward bolster member, a back bolster member and elongated, spaced, medial strips mounted to said closed plate members and which form generally transversely opposed sides defining a pair of spaced, generally parallel planes.

11. The sliding blade knife of claim 7 wherein said frame at one side provides a protective sheath which fully receives the blade in the retracted position.
